(19) United States
(12) Patent Application Publication
(10) Pub. No.: US 2016/0374315 A1
(43) Pub. Date: Dec. 29, 2016

(54) ANIMAL TRAINING DEVICE AND METHOD

(71) Applicant: Margaret Stasi, Port Jefferson, NY (US)

(72) Inventor: Margaret Stasi, Port Jefferson, NY (US)

(21) Appl. No.: 14/751,504

(22) Filed: Jun. 26, 2015

(51) Int. Cl. A01K 15/02

(52) U.S. Cl. CPC A01K 15/02

(57) ABSTRACT

A training device for a dog includes a first cuff element configured for attachment to a first hind leg of a dog, a second cuff element configured for attachment to a second hind leg of the dog and a connecting element connecting the first cuff element to the second cuff element and sized to prevent the dog from lifting either the first hind leg or the second hind leg to the side or separate the hind legs to squat. The device prevents the dog from urinating when wearing the device. When the dog alerts its owner that urination is necessary, the owner takes the dog outside and removes the device so the dog can urinate. Upon returning inside, the device is replaced on the dog.

### BACKGROUND

Field of the Disclosure

The present invention relates to a device for training a pet and a method for using the same to train a pet. More particularly, the present invention relates to a training device worn on the hind legs of a dog to aid in house breaking the dog by preventing the dog from urinating while wearing the device.

Related Art

House breaking a dog may be a long and frustrating process. Many pet owners must go through this process after purchase or adoption of a dog. Traditional methods include the use of so-called wee-wee pads which tend to have limited effectiveness. Some products are available for this purpose that are similar to diapers or wraps. While these products may minimize the damage that untrained dogs cause, they do not provide much help in actually training the dogs not to relieve themselves indoors. An untrained dog, whether a puppy or older dog, poses problems for an owner that may detract from the joy of owning a pet.

It is particularly common for rescue animals not to be trained or to not be sufficiently trained. Adoption of these animals may therefore be complicated by this lack of training That is, a potential adopter may not wish to adopt, or to keep, an adoptable dog if it is difficult to house train the dog.

Accordingly, it is desirable to provide a training device and method for house breaking a dog that simplifies and shortens the training process.

### SUMMARY OF THE INVENTION

It is an object of the present invention to provide a device for house training a dog and a method for use therewith. In particular, it is an object of the present application to provide a device that prevents a dog from urinating that can be easily applied and removed from the dog and a method using this device to house train a dog.

A training device in accordance with an embodiment of the present invention includes a first cuff element configured for attachment to a first hind leg of a dog, a second cuff element configured for attachment to a second hind leg of the dog and a connecting element connecting the first cuff element to the second cuff element and sized to limit lateral separation of the first hind leg from the second hind leg.

A method of training a dog in accordance with an embodiment of the present invention includes securing a training device to the dog's hind legs when the dog is in an inside environment, adjusting the securing device such that the dog cannot lift its hind legs to the side or separate its hind legs to squat, taking the dog outside the inside environment when the dog indicates a need to urinate and removing the training device from the dog once outside the inside environment.

Other features and advantages of the present invention will become apparent from the following description of the invention which refers to the accompanying drawings.

### BRIEF DESCRIPTION OF THE DRAWINGS

FIG. 1 illustrates an exemplary embodiment of a training device in accordance with the present disclosure.

FIG. 2A illustrates the training device of FIG. 1 worn by a dog.

FIG. 2B illustrates an alternate embodiment of a training device in accordance with the present disclosure worn by a dog.

FIG. 2C illustrates a more detailed view of an alternative embodiment of the cuff portion of the device of FIG. 1.

FIG. 3 illustrates a more detailed view of the cuff portions of the training device of FIG. 1.

FIG. 4 illustrates a more detailed view of a connecting element connecting the cuff portions of the training device of FIG. 1.

FIG. 5A illustrates a more detailed view of a cuff element of the device of FIG. 1 covered by a fabric sleeve.

FIG. 5B illustrates an embodiment of the training device of FIG. 1 with an alternative connecting element.

FIG. 6 illustrates an alternate embodiment of a connecting element for use in the device of FIG. 1.

FIG. 7 illustrates another alterative embodiment of a connecting element for use in the device of FIG. 1.

FIG. 8 illustrates another alternative embodiment of a connecting element for use in the device of FIG. 1.

FIG. 9 illustrates an exploded view of a fastening element of the connecting element of FIG. 8.

FIG. 10 illustrates an exemplary flow chart showing the steps for training a dog using the device of FIG. 1.

FIG. 11 illustrated the device of claim 10 in which both cuff elements include a fabric sleeve.

### DETAILED DESCRIPTION OF THE EMBODIMENTS

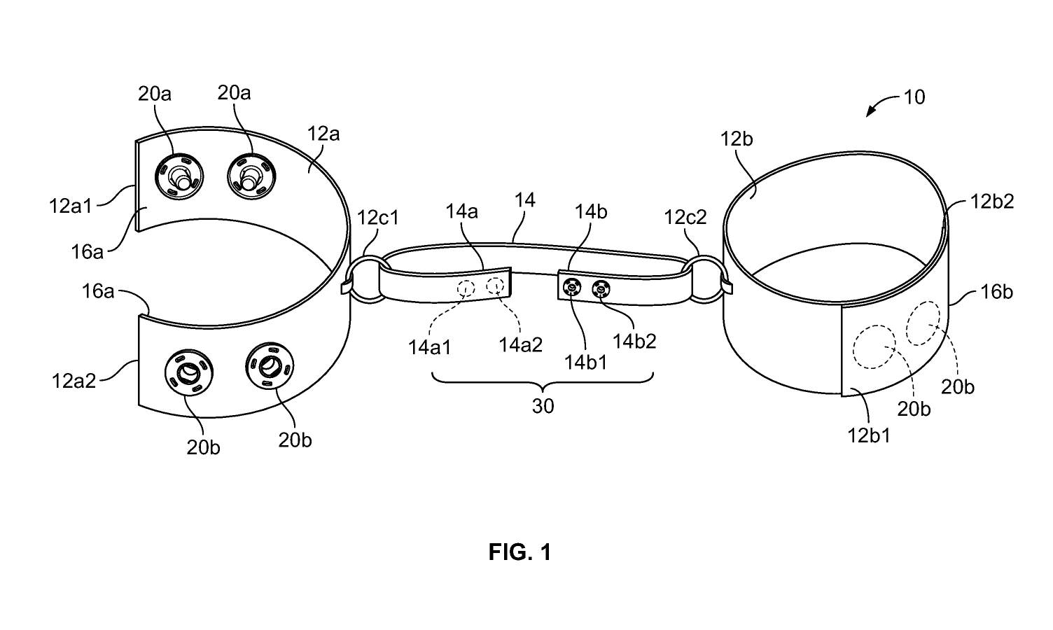

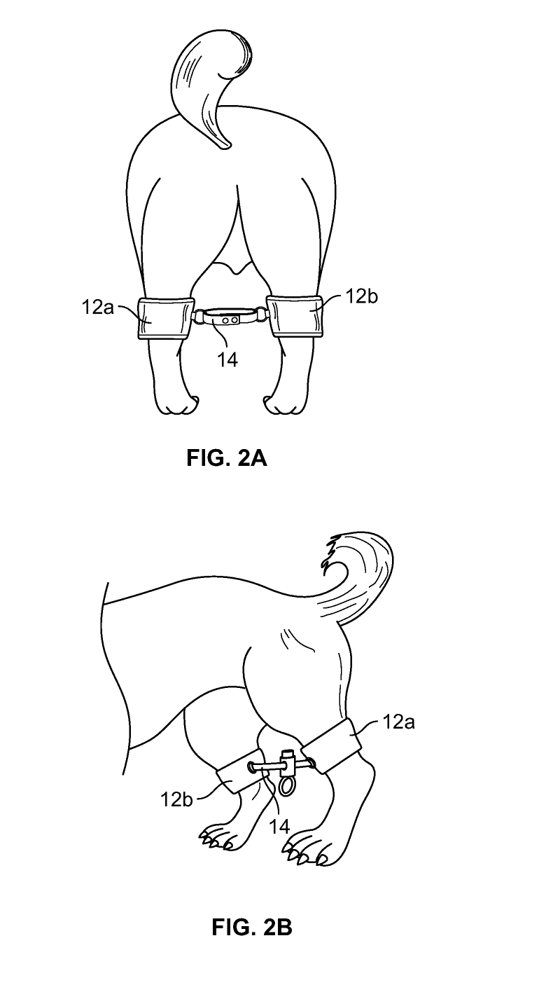

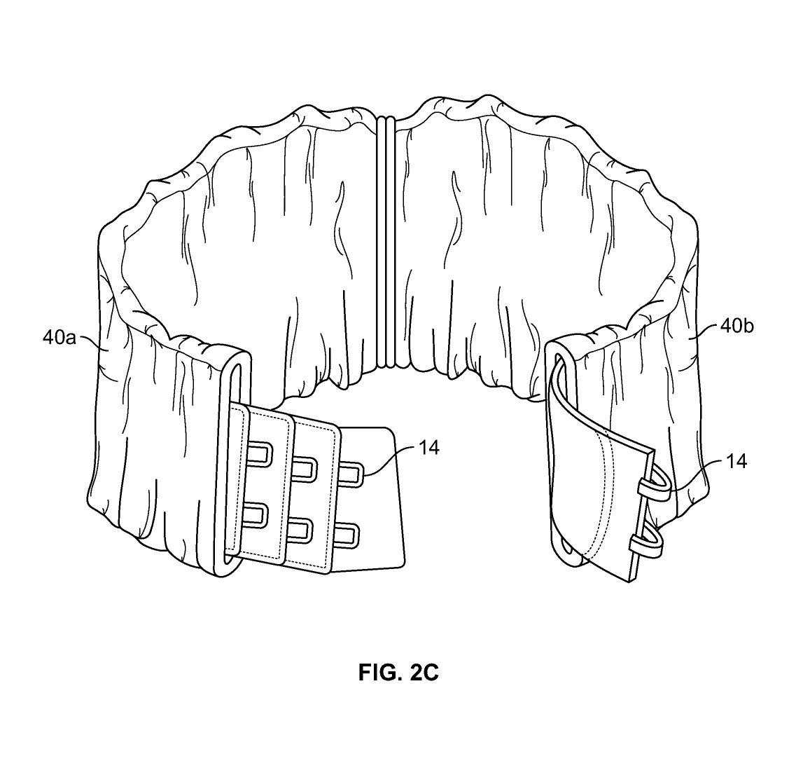

FIG. 1 illustrates an exemplary embodiment of a training device 10 for use in house breaking a pet, such as a dog. The device 10 preferably includes a pair of cuff elements 12a, 12b connected to each other via a connecting element 14. In use, the cuff elements 12a, 12b are secured to the hind legs of the dog to be trained. In a preferred embodiment, the cuff elements 12a, 12b are secured just above the ankle of the dog's hind legs where the leg changes direction, as can be seen in FIG. 2A, for example. This change in direction of the leg helps to hold the cuff elements 12a, 12b in place on the dog's hind legs. The connecting element 14 joins the cuff elements 12a, 12b together. The length of the connecting element 14 is set such that the dog is able to walk, run, climb stairs, sit, lay down and jump, but limits the ability of the dog to separate his/her hind legs. Typically, a male dog needs to lift his leg to the side approximately forty-five degrees in order to urinate. The length of the connecting element 14 is set to prevent this movement and separation of the dog's hind legs from each other. Thus, the dog is unable to urinate while wearing the device 10. While female dogs do not need to lift their hind leg in order to urinate, they do need to separate their hind legs laterally somewhat in order to squat down. The length of the connecting element 14 is set to prevent this squatting position as well. Typically, the separation between portions of the hind legs of a squatting female dog will be similar to the separation between the legs of a male dog of similar size lifting its leg such that the length of the connecting element is set to prevent this separation. When the device 10 is removed, the dog is able to urinate in the normal manner. In a preferred embodiment, the device 10 is used as part of a training process where the dog wears the device 10 when inside a home, apartment or other indoor environment. When the dog needs to urinate, the owner takes the dog outside and removes the device 10 so the dog can urinate. It is preferred that following urination outside, the dog is praised or otherwise rewarded for good behavior to reinforce the behavior of urinating outside. The device 10 is put back on the dog when the dog goes indoors.

In a preferred embodiment, each cuff element 12a, 12b is preferably embodied as a length of material that may be wrapped around the hind leg of the dog, as illustrated in FIG. 2A, for example. FIG. 2B illustrates an alternate embodiment of the device 10 with the cuff elements 12a, 12b attached to the dog's hind legs. The material of the cuff elements 12a, 12b is preferably elastic, but examples of suitable material for the cuff elements include but are not limited to sheepskin, leather, suede, fleece, corduroy, flannel, canvas, quilted cotton, denim, reinforced mesh or other natural or synthetic fabrics. Each cuff element 12a, 12b preferably includes a respective attachment element 16a, 16b that is used to secure first ends 12a1, 12b1 of each of the cuff elements 12a, 12b to the second ends 12a2, 12b2 thereof, respectively, to encircle the dog's leg. In order to provide a snug fit on the dog's leg, the size of the loop formed by the cuff elements 12a, 12b is preferably adjustable, using adjustment elements 16a, 16b, respectively.

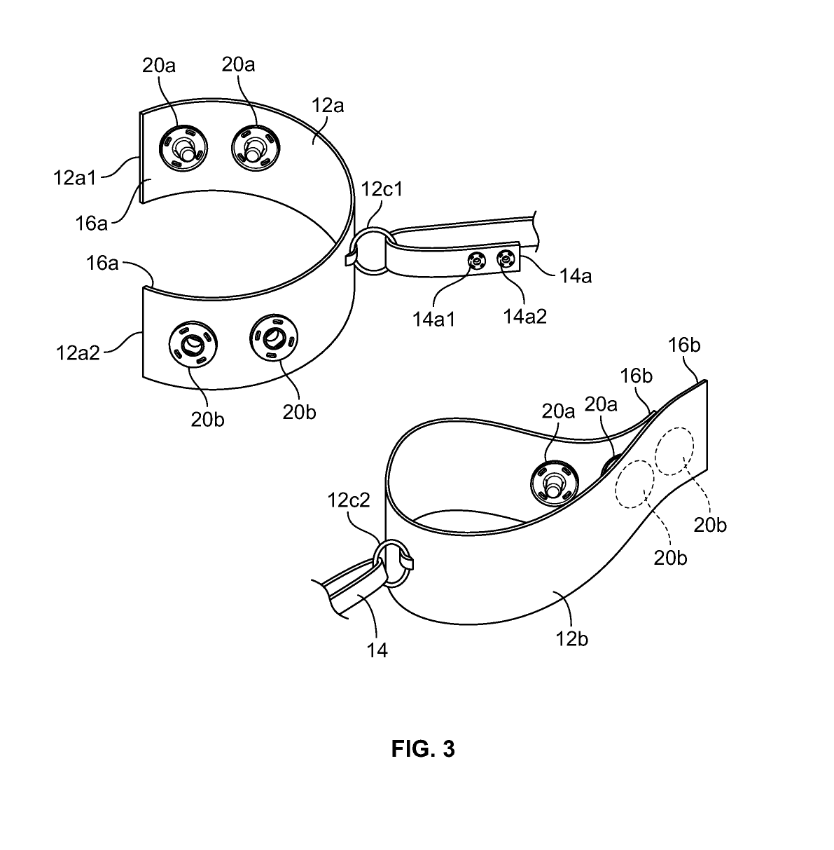

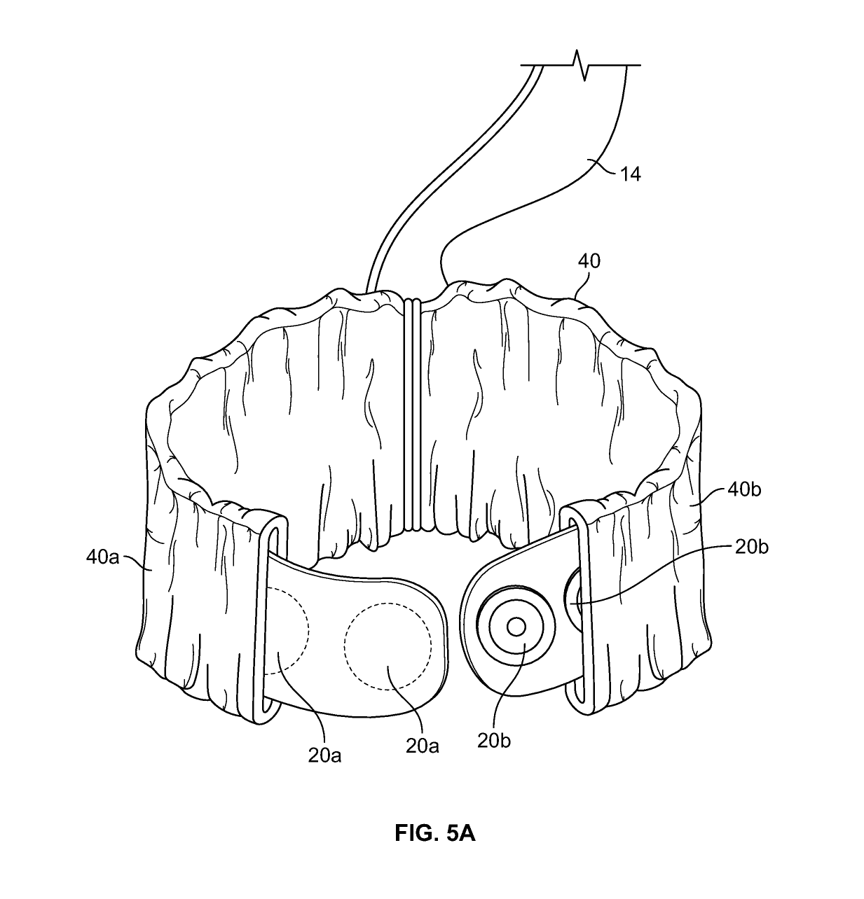

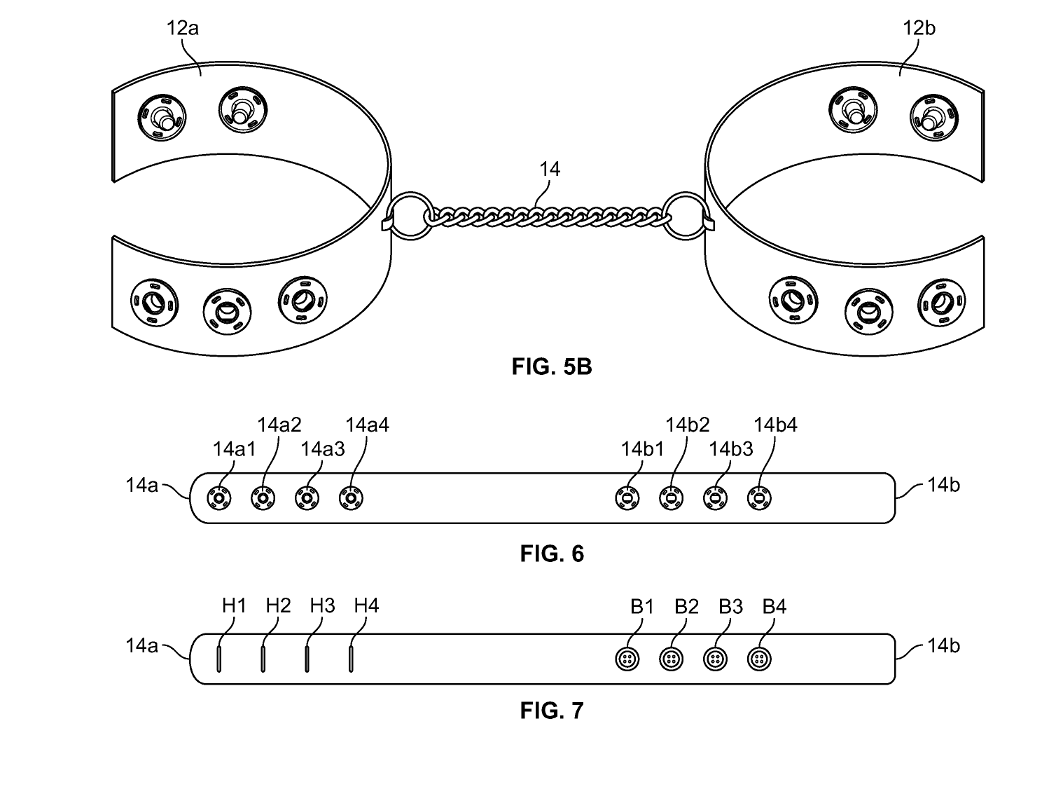

The adjustment elements 16a, 16b illustrated in FIGS. 1 and 3, for example, include a snap fastener at the ends of the cuffs 12a, 12b that allows for adjustment of the loop size. As illustrated, at least two first snap elements 20a are provided on the first end 12a1, 12b1 of each cuff element 12a, 12b, while at least two second snap elements 20b are formed on the opposite end 12a2, 12b2 of each cuff element. By providing multiple first snap elements 20a and multiple second snap elements 20b, the size of the loop formed by the cuff elements 12a, 12b is adjustable by mating different first snap elements with different second snap elements. While two first snap elements 20a and two second snap element 20b are shown, additional snap elements may be provided to allow for adjustment of the cuff elements 12a, 12b over a larger range. In addition, a single first snap element 20a may be used in conjunction with multiple second snap elements 20b and still allow for adjustment of the length of the connecting element 14, and vice versa. As mentioned above, in a preferred embodiment, each of the cuff elements 12a, 12b is made of an elastic material such that they stretch to accommodate the leg of the dog and provide a snug fit. In an embodiment, an outer fabric sleeve 40 may be provided on the cuff elements 12a, 12b for comfort. This fabric sleeve 40 may be padded, if desired for added comfort for the dog. The sleeve 40 preferably slides along the cuff element 12a, 12b, or is otherwise adjustable to cover and uncover the adjustment elements 16a, 16b. The adjustment elements 16a, 16b are preferably covered while the animal is wearing the device, however, are easily uncovered to allow for removal of the device 10 when desired. In a preferred embodiment, the sleeve 40 is completely removable from the cuff element 12a, 12b to facilitate cleaning of the cuff element and/or the sleeve 40. In a preferred embodiment, the sleeve 40 is divided into two parts 40a, 40b as can be seen in FIG. 5A, for example, to simplify removal from the cuff element 40. While the connecting element 14 is preferably made of an elastic material, more durable materials may be used, for example, a metal chain, as illustrated in FIG. 5B. Such a durable material would be useful for dogs that habitually chew on the connecting element 14. FIG. 11 illustrate the device 10 of FIG. 1 in which both of the cuff elements 12a, 12b include fabric sleeves 40.

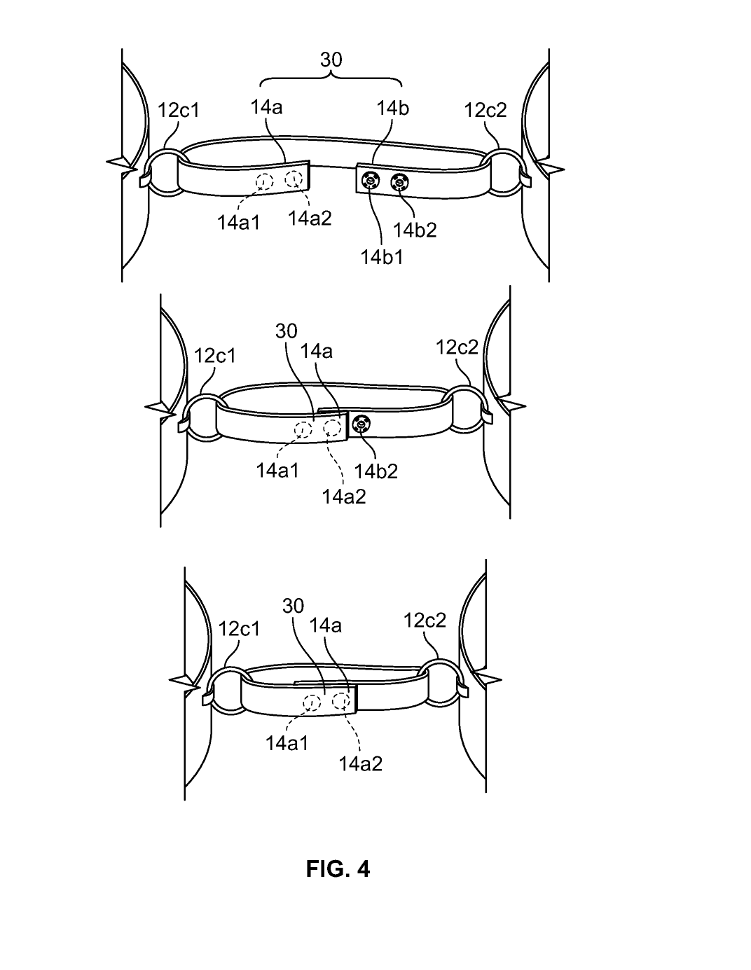

In a preferred embodiment, the connecting element 14 is also adjustable in length so that it can be adjusted for use on a particular dog. In a preferred embodiment, the connecting element 14 is also made of an elastic material such that it stretches to some extent. The length of the connecting element 14 is preferably adjustable using fastening element 30, which fastens a first end 14a of the connecting element 14 to the second end 14b thereof. As illustrated in FIGS. 1 and 4, for example, the first end 14a passes through a first connecting ring 12c1 secured to one of the cuff elements 12a, 12b and the second end 14b passes through a second connecting ring 12c2 of the other of the cuff elements 12a, 12b. The first and second ends 14a, 14b of the connecting element 14 are fastened to each other to hold the cuff elements 12a, 12b together. As illustrated in FIGS. 1 and 4, a snap connection is provided between the first and second ends 14a and 14b of the connecting element 14 via fastening element 30. In an embodiment, the fastening element 30 includes at least two first connecting snap elements 14a1, 14a2 provided on the first end 14a of the connecting element 14 and at least two second connecting snap elements 14b1, 14b2 provided on the second end 14b of the connecting element 14. One or more of the first connecting snap elements 14a1, 14a2 is received by at least one of the second connecting snap elements 14b1, 14b2 to secure the ends 14a and 14b together. Use of multiple snap elements allows for adjustment of the length of the connection element 14 within a certain range to ensure comfort for the dog and efficacy of the device 10 as can be seen in FIG. 4, for example. Additional first connecting snap elements and second connecting snap elements may be provided if desired. A single first connecting snap element may be used provided that multiple second connecting snap elements are provided and to allow for adjustment in the length of the connecting element 14, and vice versa.

In another embodiment of the connecting element 14 illustrated in FIG. 6, for example, additional connecting snap elements are provided. In this embodiment, the first connecting snap elements 14a1, 14a2, 14a3, 14a4 may pass through a securing ring, such as the securing ring 12c1 or 12c2 connected to one of the cuff elements 12a, 12b and are received by one or more of the second connecting snap elements 14b1, 14b2, 14b3, 14b4. The connecting snap elements in this embodiment are not positioned on opposite ends of the connecting element, but rather are positioned more toward one end thereof. The other end of the connecting element 14 is preferably secured to the other cuff element 12a, 12b, either via a connecting ring or directly.

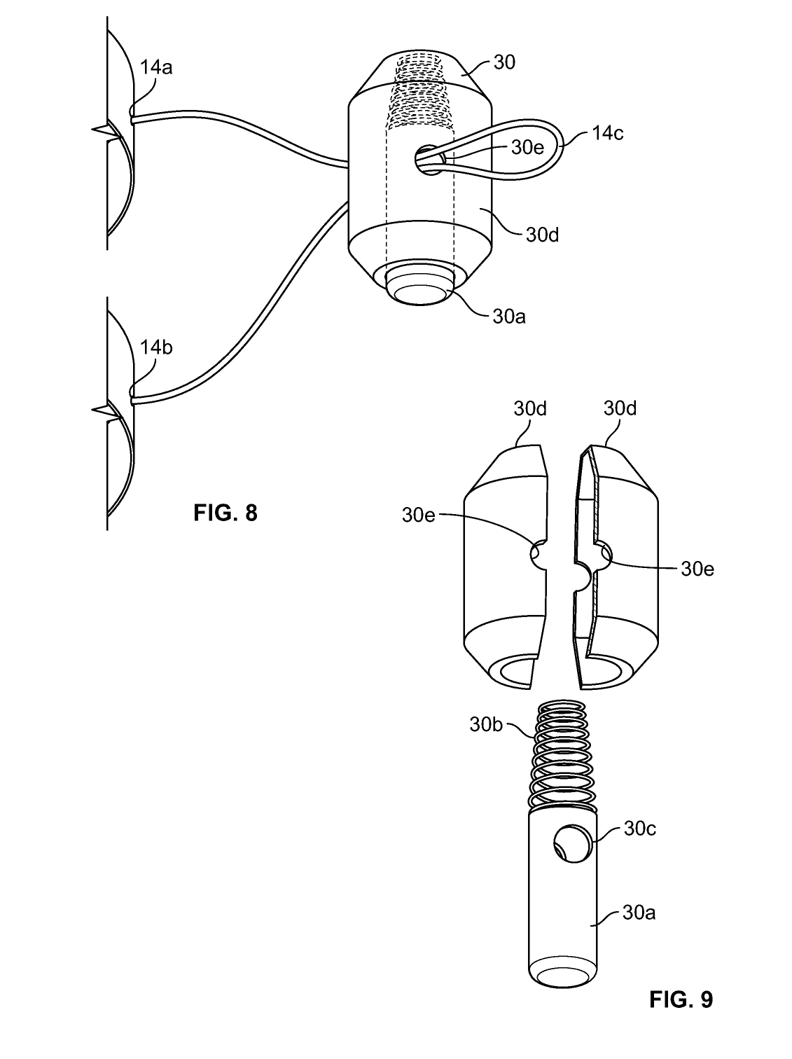

While the present disclosure discusses the use of snap closures in the adjustment elements 16a, 16b and the fastening element 30, other fasteners may be used, including but not limited to buttons (See FIG. 7, for example), hook and eye closures or hook and loop type fasteners. FIG. 2C illustrates an example of a cuff 12a, 12b utilizing hook and eye type fasteners as the adjustment element 16a, 16b. FIG. 8 illustrates an alternate embodiment of the fastening element 30. In this embodiment, the ends 14a, 14b of the connecting element 14 are attached to the cuffs 12a, 12b, respectively, either via rings 12c1 and 12c2, for example, or directly and adjustment of the length of the connecting element occurs using the fastening element 30. As can be seen in FIG. 9, a loop 14c may be provided in the connecting element 14 that passes through the fastening element 30. The size of the loop 14c may be changed to change the length of the connecting element 14. The fastening element 30 may be used to secure the loop 14c, and thus, set the length of the connecting element 14. Depressing the button 30a of the fastening element 30 releases it to allow for adjustment of the length of the connecting element 14. A spring 30b (see FIG. 9, for example) biases the button 30a into the locked position to secure the loop 14c and set the length of the connecting element 14. More specifically, the loop 14c passes through a slot 30c formed in the button 30a which is aligned with the openings 30e formed in the fastening element housing 30d when the fastening element 30 is open to release the loop when the button 30a is pressed. When the button 30a is not pressed, the spring 30b biases the button 30a in a locked position such that slot 30c is not aligned with the opening 30e in the housing 30d of the fastening element 30 to prevent adjustment of the length of the loop 14c and the connecting element 14.

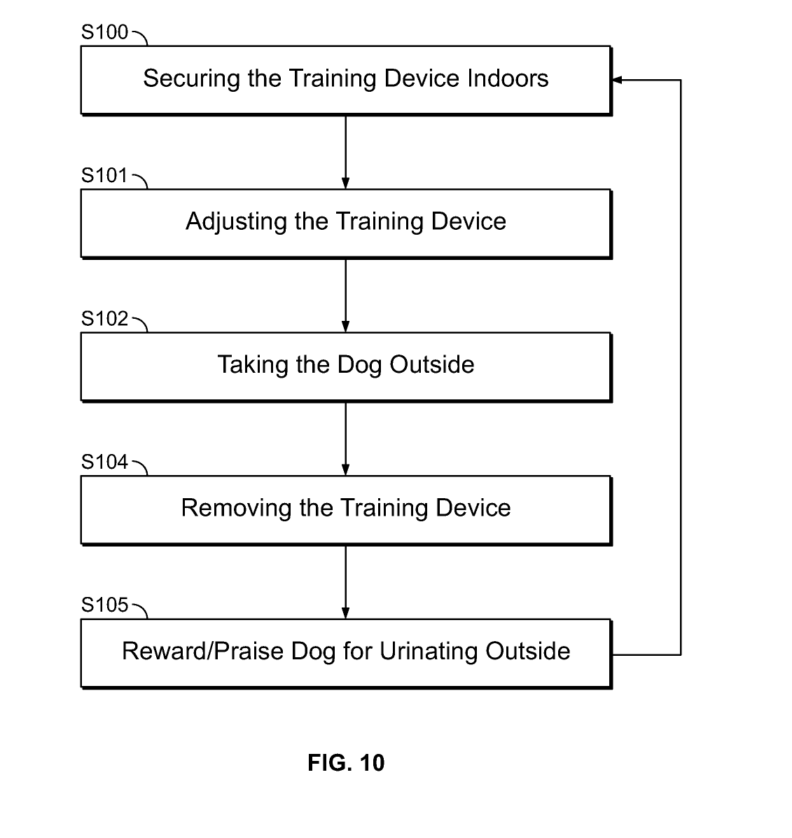

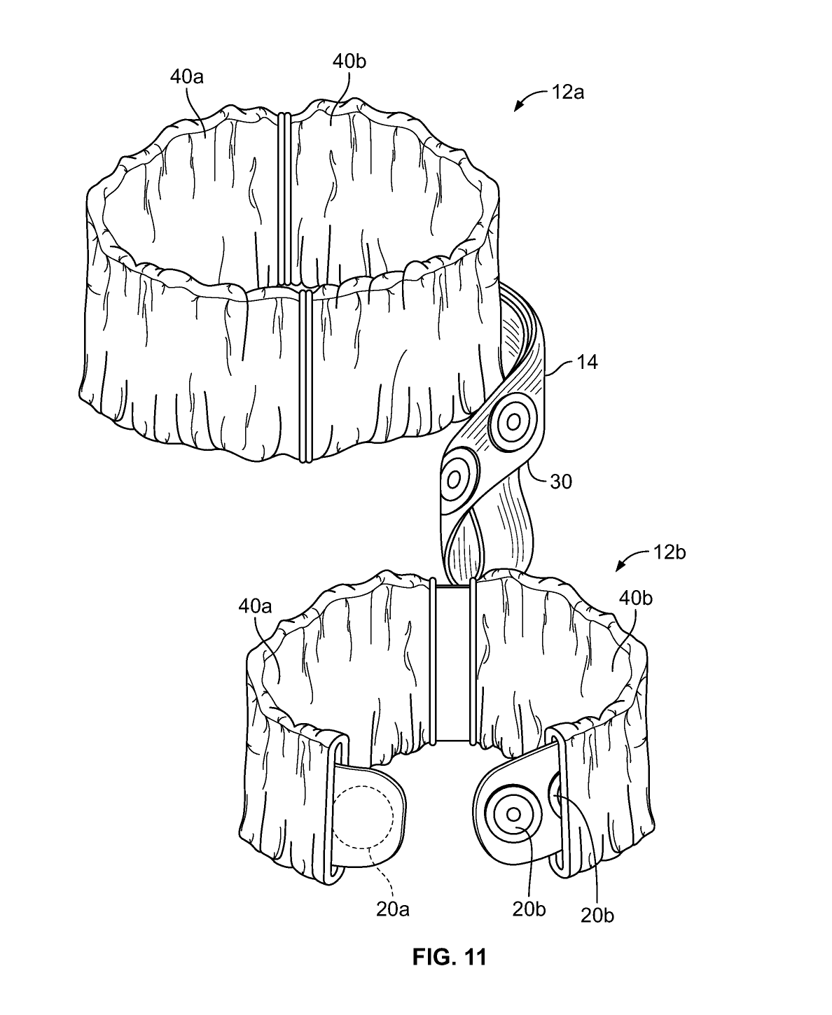

In a preferred embodiment illustrated in FIG. 10, the device 10 may be used as part of a process for house training a dog. In a first step S100, the device 10 is put on a dog when the dog is indoors. The length of the connecting element 14 is adjusted such that the dog cannot lift his leg to the side in step S101. In step S102, when the dog indicates that he or she needs to urinate, the dog's owner takes the dog outside. Thereafter, the owner takes the device off of the dog while outside at step S104 so the dog can urinate. In a preferred embodiment, after the dog urinates outside, the dog's owner praises or otherwise rewards the dog for urinating outside (see step 105, for example). If the user takes the dog back inside, he or she puts the device back on the dog, as in step 100. In most cases readjustment of the device 10 will not be necessary, but may be performed if desired. Since the method of FIG. 10 encourages the dog to engage in the desired behavior of urinating outside, rather than just reducing the negative effects of indoor urination, the method acts to train the dog and results in improved behavior.

The training device 10 and the method described above simplify and expedite house breaking a dog. As a result, adoption of untrained dogs is encouraged since the negative aspects of training are minimized and the number of dogs returned to shelters will be greatly reduced.

Although the present invention has been described in relation to particular embodiments thereof, many other variations and modifications and other uses will become apparent to those skilled in the art.

What is claimed is:

1. A training device comprising:
a first cuff element configured for attachment to a first hind leg of a dog;
a second cuff element configured for attachment to a second hind leg of the dog; and
a connecting element connecting the first cuff element to the second cuff element and sized to prevent the dog from lifting the first hind leg or the second hind leg to the side and to limit lateral separation of the first hind leg from the second hind leg.

2. The dog training device of claim 1, wherein the first cuff element includes a first adjustment element configured to adjust a length of the first cuff element.

3. The dog training device of claim 2, wherein the second cuff element includes a second adjustment element configured to adjust a length of the second cuff element.

4. The dog training device of claim 1, wherein the connecting element further comprises a fastening element configured to adjust a length of the connecting element to limit lateral separation of the first hind leg from the second hind leg.

5. The dog training device of claim 1, wherein the first cuff element and second cuff element are made of an elastic material.

6. The dog training device of claim 1, wherein the connecting element is made of an elastic material.

7. The dog training device of claim 3, further comprising at least one fabric sleeve mounted on at least one of the first cuff element and the second cuff element.

8. The dog training device of claim 7, wherein the at least one fabric sleeve element includes a first element and a second element.

9. The dog training device of claim 8, wherein the first element and the second element are movable relative to the at least one of the first cuff element and the second cuff element to cover and uncover the first adjustment element or second adjustment element.

10. The dog training device of claim 7, wherein the first fabric sleeve further comprises padding.

11. The dog training device of claim 7, wherein the second fabric sleeve further comprises padding.

12. The dog training device of claim 3, wherein the first adjustment element comprises at least three snap elements that provide a snap connection between opposite ends of the first cuff element.

13. The dog training device of claim 3, wherein the second adjustment element comprises at least three snap elements that provide a snap connection between opposite ends of the first cuff element.

14. The dog training device of claim 1, wherein the fastening element further comprises at least three snap elements that provide an adjustable snap connection between opposite ends of the connecting element.

15. A method of training a dog comprising:
securing a training device to the dog's hind leg's when the dog is in an inside environment;
adjusting the securing device such that the dog cannot lift its hind legs to the side or separate its hind legs to squat;
taking the dog outside the inside environment when the dog indicates a need to urinate; and
removing the training device from the dog once outside the inside environment.

16. The method of training of claim 16, further comprising:
rewarding the dog after the dog urinates outside the inside environment.

17. The method of training of claim 16, further comprising:
bringing the dog back into the inside environment; and
repeating the step of securing the training device.
